(19) United States
(12) Patent Application Publication
(10) Pub. No.: US 2026/0045251 A1
(43) Pub. Date: Feb. 12, 2026

(54) METHOD FOR REDUCING SKIP RATES IN SPEECH DATA LABELING

(71) Applicant: VIETTEL GROUP, Ha Noi City (VN)

(72) Inventors: Van Hai Do, Ha Noi (VN); Bao Thang Ta, Gia Binh District (VN); Minh Khang Pham, Ha Noi (VN); Nhat Minh Le, Ha Noi (VN); Ngoc Dung Nguyen, Ha Noi (VN); Manh Quan Tran, Ha Noi (VN); Manh Quy Nguyen, Ha Noi (VN)

(73) Assignee: VIETTEL GROUP, Ha Noi City (VN)

(21) Appl. No.: 18/953,737

(22) Filed: Nov. 20, 2024

(30) Foreign Application Priority Data
Aug. 6, 2024 (VN) 1-2024-05861

(51) Int. Cl. G10L 15/04; G10L 15/16

(52) U.S. Cl. CPC G10L 15/04; G10L 15/16

(57) ABSTRACT

The invention proposes a method to reduce the skip rate in speech data labeling, which is carried out through the following steps: Step 1: Collecting Speech Segments for Text Labeling; Step 2: Text Labeling of the Speech Segments; Step 3: Creating a Training Set for a Machine Learning Model; Step 4: Building the Machine Learning Model; Step 5: Training the Machine Learning Model; Step 6: Using the Machine Learning Model to Filter Data. The method helps reduce time and increase productivity in the speech data labeling process while ensuring data quality. The method employs a machine learning model to learn the behavior of skipping or not skipping speech segments by the labelers, thereby eliminating segments likely to be skipped before presenting the data to the labelers.

### BACKGROUND

### 1. Technical Field

The invention relates to a method to reduce the skip rate in speech data labeling. Specifically, the method aims to reduce the skip rate during the speech data labeling process, thus improving productivity while maintaining data quality.

### 2. Introduction

With the rapid development of artificial intelligence, especially in speech processing, the demand for labeled data has significantly increased to train machine learning models. Speech data labeling involves human labelers listening to and transcribing the content of speech segments. However, not all speech segments are clearly audible, due to factors such as poor quality, noisy environments, or low volume, which may cause the labelers to skip these segments. This leads to wasted time and effort. Therefore, there is a need for an automatic method to detect segments likely to be skipped during labeling, to reduce wasted time and improve labeling productivity.

### BRIEF DESCRIPTION OF THE DRAWINGS

FIG. 1 illustrates the process to build the machine learning model (from step 1 to step 5).

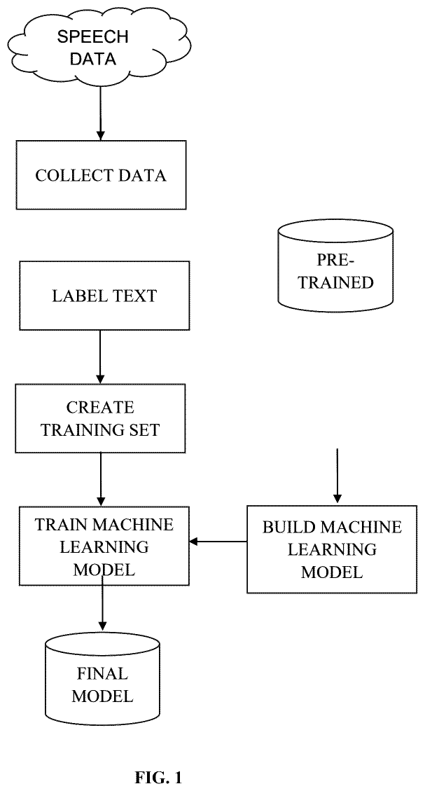

FIG. 2 illustrates the process for automatically applying the machine learning model to filter data (step 1 and step 6).

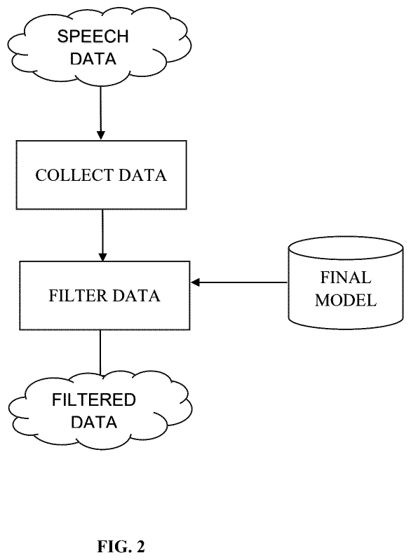

### DETAILED DESCRIPTION

This present invention aims to propose a method to reduce the skip rate during speech data labeling, to enhance productivity.

Specifically, the present invention provides a method including:

Step 1: Collecting Speech Segments for Text Labeling. Speech segments requiring text labeling are collected. The collection can be done using various methods, such as directly recording from a microphone or retrieving speech data from storage devices. The duration D of the speech segments must satisfy a condition 0.3 seconds≤D≤30 seconds, ensuring that the segments are neither too short nor too long for a labeler to easily listen and assign text labels.

Step 2: Text Labeling of the Speech Segments. The collected speech segments from Step 1 are uploaded to a labeling system, where labelers listen and input corresponding text accurately. If a labeler cannot clearly hear or accurately transcribe the speech segment, the segment is skipped. Skipping may occur due to various factors, such as poor audio quality, excessive background noise, or very low speech volume.

Step 3: Creating a Training Set for a Machine Learning Model. When a total labeled speech duration exceeds H hours of data (with H≥1 hour), an administrator selects a random subset of labeled speech segments from Step 2 to create a training set for the machine learning model. Segments skipped by labelers are marked as “1”, while others are labeled as “0”.

Step 4: Building the Machine Learning Model. The model is designed to detect speech segments likely to be skipped by labelers. The machine learning model is based on deep learning architectures, including a CONFORMER architecture, which combines convolutional neural networks (CNNs) for capturing local features of speech signals with a TRANSFORMER architecture for modeling sequential features. The machine learning model weights can be initialized from scratch or from pre-trained models, such as those used in speech recognition tasks. To handle varying lengths of speech segments, an Attentive Statistics Pooling Layer (ASP) is added to synthesize a unified result regardless of speech input length. Use of an attention mechanism helps the model assign importance to different frames of speech for determining quality. The machine learning model has two outputs, oₛₖᵢₚ and oₙₒₛₖᵢₚ, representing the likelihood of skipping or not skipping the input speech segment.

Step 5: Training the Machine Learning Model. The machine learning model is trained based on the deep learning architecture built in Step 4 and the training set created in Step 3. A loss function used for training is cross-entropy. An initial learning rate α is selected within a range 0.01≥α≥0.00001. This range ensures that the learning rate is neither too small, which would slow the training, nor too large, which could prevent the machine learning model from converging. After training, the machine learning model can simulate a behavior of labelers in skipping or not skipping speech segments. This trained model will be used to filter data in Step 6.

Step 6: Using the Machine Learning Model to Filter Data. The trained machine learning model from Step 5 is applied to the speech data collected in Step 1. For each input speech segment, the machine learning model outputs a value pₛₖᵢₚ at the oₛₖᵢₚ output, representing a likelihood that a labeler would skip that segment. Only segments satisfying pₛₖᵢₚ≤β are selected for labeling, where a threshold β must satisfy 0.01≤β≤0.99. The threshold β is determined by the administrator. A larger β retains more data, but may include segments likely to be skipped. A smaller β filters out more segments, potentially increasing labeling efficiency, but may exclude some segments that could be labeled.

### DETAILED DESCRIPTION OF THE INVENTION

The invention is detailed below, specifically, a method for reducing skip rates in speech data labeling of noise modeling to the method aims to reduce the skip rate during the speech data labeling process comprising of steps:
Step 1: Collecting Speech Segments for Text Labeling;
Step 2: Text Labeling of the Speech Segments;
Step 3: Creating a Training Set for a Machine Learning Model;
Step 4: Building the Machine Learning Model;
Step 5: Training the Machine Learning Model;
Step 6: Using the Machine Learning Model to Filter Data.

The details of these steps are as follows:

Step 1: Collecting Speech Segments for Text Labeling. Speech segments requiring text labeling are collected. The collection can be done using various methods, such as directly recording from a microphone or retrieving speech data from storage devices. The duration D of the speech segments must satisfy a condition 0.3 seconds≤D≤30 seconds, ensuring that the segments are neither too short nor too long for a labeler to easily listen and assign text labels.

Step 2: Text Labeling of the Speech Segments. The collected speech segments from Step 1 are uploaded to a labeling system, where labelers listen and input corresponding text accurately. If a labeler cannot clearly hear or accurately transcribe the speech segment, the segment is skipped. Skipping may occur due to various factors, such as poor audio quality, excessive background noise, or very low speech volume.

Step 3: Creating a Training Set for a Machine Learning Model. When a total labeled speech duration exceeds H hours of data (with H≥1 hour), an administrator selects a random subset of labeled speech segments from Step 2 to create a training set for the machine learning model. Segments skipped by labelers are marked as “1”, while others are labeled as “0”.

Step 4: Building the Machine Learning Model. The model is designed to detect speech segments likely to be skipped by labelers. The machine learning model is based on deep learning architectures, including a CONFORMER architecture, which combines convolutional neural networks (CNNs) for capturing local features of speech signals with a TRANSFORMER architecture for modeling sequential features. The machine learning model weights can be initialized from scratch or from pre-trained models, such as those used in speech recognition tasks. To handle varying lengths of speech segments, an Attentive Statistics Pooling Layer (ASP) is added to synthesize a unified result regardless of speech input length. Use of an attention mechanism helps the model assign importance to different frames of speech for determining quality. The machine learning model has two outputs, oₛₖᵢₚ and oₙₒₛₖᵢₚ, representing the likelihood of skipping or not skipping the input speech segment.

Step 5: Training the Machine Learning Model. The machine learning model is trained based on the deep learning architecture built in Step 4 and the training set created in Step 3. A loss function used for training is cross-entropy. An initial learning rate α is selected within a range 0.01≥α≥0.00001. This range ensures that the learning rate is neither too small, which would slow the training, nor too large, which could prevent the machine learning model from converging. After training, the machine learning model can simulate a behavior of labelers in skipping or not skipping speech segments. This trained model will be used to filter data in Step 6.

Step 6: Using the Machine Learning Model to Filter Data. The trained machine learning model from Step 5 is applied to the speech data collected in Step 1. For each input speech segment, the machine learning model outputs a value pₛₖᵢₚ at the oₛₖᵢₚ output, representing a likelihood that a labeler would skip that segment. Only segments satisfying pₛₖᵢₚ≤β are selected for labeling, where a threshold β must satisfy 0.01≤β≤0.99. The threshold β is determined by the administrator. A larger β retains more data, but may include segments likely to be skipped. A smaller β filters out more segments, potentially increasing labeling efficiency, but may exclude some segments that could be labeled.

### Examples of Invention

The proposed method was implemented to select labeled data at the Viettel Group. Applying this method reduced the number of speech segments skipped by labelers by 50%, while retaining 94% of the usable segments that could be listened to and labeled.

In trials at the Viettel Group, labelers spent an average of 19 seconds per sentence to decide whether to skip it, even though most of the speech segments in the test dataset were only between 7 and 25 seconds long. This is because labelers often had to listen multiple times before deciding if a segment could be labeled or should be skipped. By applying the proposed solution, we saved approximately 200 work hours in building a dataset of 120,000 speech segments. The experiments showed that the quality of the data created using the proposed solution was comparable to the quality achieved without it in training a speech recognition system. As a result, the proposed method helped reduce labeling time while maintaining the quality of the dataset.

### Effect of Invention

The particular advantage of this invention is the provision of a method for selecting data, thus reducing the skip rate during speech data labeling. This method was successfully applied at the Viettel Group, reducing the time and cost of dataset construction while maintaining data quality.

Although the above descriptions contain many specifics, they are not intended to be a limitation of the embodiment of the invention but are intended only to illustrate some preferred execution.

1. A method to reduce the skip rate in speech data labeling, comprising the steps of:
step 1: collecting speech segments for text labeling; speech segments requiring text labeling are collected; the collection can be done using various methods, such as directly recording from a microphone or retrieving speech data from storage devices; the duration D of the speech segments must satisfy a condition 0.3 seconds≤D≤30 seconds, ensuring that the segments are neither too short nor too long for a labeler to easily listen and assign text labels;
step 2: text labeling of the speech segments; the collected speech segments from step 1 are uploaded to a labeling system, where labelers listen and input corresponding text accurately; if a labeler cannot clearly hear or accurately transcribe the speech segment, the segment is skipped; skipping may occur due to various factors, such as poor audio quality, excessive background noise, or very low speech volume;
step 3: creating a training set for a machine learning model; when a total labeled speech duration exceeds H hours of data (with H≥1 hour), an administrator selects a random subset of labeled speech segments from step 2 to create a training set for the machine learning model; segments skipped by labelers are marked as “1”, while others are labeled as “0”;
step 4: building the machine learning model; the model is designed to detect speech segments likely to be skipped by labelers; the machine learning model is based on deep learning architectures, including a CONFORMER architecture, which combines convolutional neural networks (CNNs) for capturing local features of speech signals with a TRANSFORMER architecture for modeling sequential features; machine learning model weights can be initialized from scratch or from pre-trained models, such as those used in speech recognition tasks; to handle varying lengths of speech segments, an Attentive Statistics Pooling Layer (ASP) is added to synthesize a unified result regardless of speech input length; use of an attention mechanism helps the model assign importance to different frames of speech for determining quality; the machine learning model has two outputs, oₛₖᵢₚ and oₙₒₛₖᵢₚ, representing a likelihood of skipping or not skipping an input speech segment;
step 5: training the machine learning model; the machine learning model is trained based on the machine learning module deep architecture built in step 4 and the training set created in step 3; a loss function used for training is cross-entropy; an initial learning rate α is selected within a range 0.01≥α≥0.00001; this range ensures that the learning rate is neither too small, which would slow the training, nor too large, which could prevent the machine learning model from converging; after training, the machine learning model can simulate a behavior of labelers in skipping or not skipping speech segments; this trained model will be used to filter data in step 6;
step 6: using the machine learning model to filter data; the trained machine learning model from step 5 is applied to the speech segments data collected in step 1; for each input speech segment, the machine learning model outputs a value pₛₖᵢₚ at the oₛₖᵢₚ output, representing a likelihood that a labeler would skip that segment, only segments satisfying pₛₖᵢₚ≤β are selected for labeling, where a threshold β must satisfy 0.01≤β≤0.99; the threshold β is determined by the administrator; a larger β retains more data, but may include segments likely to be skipped; a smaller β filters out more segments, potentially increasing labeling efficiency, but may exclude some segments that could be labeled.
